(19) United States
(12) Patent Application Publication
(10) Pub. No.: US 2026/0315660 A1
(43) Pub. Date: Oct. 15, 2026

(54) Annealable Hydrogel Beads Coated With Antimicrobial DNA-Histone Matrix

(71) Applicant: The Regents of The University of Michigan, Ann Arbor, MI (US)

(72) Inventors: Priyan WEERAPPULI, West Bloomfield, MI (US); Sasha Cai LESHER-PEREZ, Ann Arbor, MI (US)

(73) Assignee: The Regents of The University of Michigan, Ann Arbor, MI (US)

(21) Appl. No.: 19/643,308

(22) Filed: Apr. 9, 2026

Related U.S. Application Data
(60) Provisional application No. 63/786,050, filed on Apr. 9, 2025.

(51) Int. Cl. A61L 27/52; A61L 27/18; A61L 27/54; C08L 71/02

(52) U.S. Cl. CPC A61L 27/52; A61L 27/18; A61L 27/54; C08L 71/02; A61L 2300/252; A61L 2300/258; A61L 2300/404; A61L 2430/34

(57) ABSTRACT

An antimicrobial microparticle is provided having a core comprising an annealable polymeric hydrogel configured to be crosslinked and an antimicrobial material disposed over at least a portion of a surface of the core. The antimicrobial material comprises a polycation comprising a polypeptide (e.g., a histone) and a polyanion comprising a nucleic acid (e.g., DNA). Antimicrobial compositions incorporating a plurality of such antimicrobial microparticles are also contemplated, which may be used on surfaces of wound dressings, medical implants, medical devices and equipment, and the like.

### CROSS-REFERENCE TO RELATED APPLICATIONS

This application claims the benefit of U.S. Provisional Application No. 63/786,050, filed Apr. 9, 2025. The entire disclosure of the above application is incorporated herein by reference.

### FIELD

The present disclosure relates to antimicrobial microparticles, namely annealable hydrogel beads coated with antimicrobial-DNA histone antimicrobial matrix, and antimicrobial compositions incorporating such microparticles.

### BACKGROUND

This section provides background information related to the present disclosure which is not necessarily prior art.

A nucleoprotein exudate material produced by innate immune systems – also referred to as neutrophil extracellular traps (NETs) – is capable of trapping bacteria through pleotropic mechanisms. This trapping results in a sustained suppression of bacterial proliferation and increased sensitivity/vulnerability to antibiotics (even when delivered at lower doses). Antimicrobial and antifouling materials are of significant interest in being applicable to many potential applications, such as wound treatment, healing, providing safer medical devices, equipment, and implants, preventing hospital acquired infections, and the like. It would be advantageous to develop new, readily accessible, antimicrobial materials to promote healing, reduce infections, and save lives, especially for acute and chronic wound treatments.

### SUMMARY

This section provides a general summary of the disclosure, and is not a comprehensive disclosure of its full scope or all of its features.

In certain aspects, the present disclosure relates to an antimicrobial microparticle. The antimicrobial microparticle may comprise a core including an annealable polymeric hydrogel configured to be crosslinked. The antimicrobial microparticle may also comprise an antimicrobial material disposed over at least a portion of a surface of the core. The antimicrobial material includes a polypeptide and a nucleic acid. The polypeptide may be a polycation and the nucleic acid may be a polyanion.

In some aspects, the annealable polymeric hydrogel is configured to be crosslinked when exposed to actinic radiation.

In some aspects, the antimicrobial microparticle is configured to be dehydrated and rehydrated.

In some further aspects, the antimicrobial microparticle in a dehydrated state has an average particle size of less than or equal to about 40 micrometers and in a rehydrated state has an average particle size of greater than or equal to about 70 micrometers.

In some aspects, the annealable polymeric hydrogel includes a polymeric precursor selected from the group consisting of: hyaluronic acid, polyalkylene glycol, alginate, gelatin, trehalose, and combinations thereof. The polymeric precursor may further include a functional group selected from the group consisting of: norbornene, maleimide, cyclononane, bicyclononyne, dibenzocyclooctyne (DBCO), dibenzoazacyclooctyne (DIBAC), vinyl sulfone, azide, tetrazine, acrylate, methacrylate, and combinations thereof.

In some aspects, the annealable polymeric hydrogel includes polyethylene glycol and further includes at least one reactive group for crosslinking.

In some aspects, the annealable polymeric hydrogel includes a crosslinking agent.

In some aspects, the nucleic acid includes deoxynucleic acid (DNA) and the polypeptide includes a histone.

In some aspects, the antimicrobial microparticle has greater than or equal to about 0.5 nanograms/microliter to 50 nanograms/microliter of DNA and greater than or equal to about 2 micrograms/milliliter to 200 micrograms/milliliter of histone.

In other aspects, the present disclosure relates to an antimicrobial composition that includes a plurality of antimicrobial microparticles. Each antimicrobial microparticle includes a core having an annealable polymeric hydrogel configured to be crosslinked and an antimicrobial material disposed over at least a portion of a surface of the core. The antimicrobial material includes a polypeptide and a nucleic acid. The polypeptide may be a polycation and the nucleic acid may be a polyanion.

In some aspects, the antimicrobial composition is configured to be directly applied to a wound or to a tissue.

In some aspects, a wound dressing includes the antimicrobial composition.

In some aspects, a medical device includes the antimicrobial composition.

In some aspects, a medical implant includes the antimicrobial composition.

In some aspects, the antimicrobial composition further includes at least one active ingredient.

In some aspects, the antimicrobial composition further includes at least one antimicrobial agent.

In some aspects, the plurality of antimicrobial microparticles are in a dehydrated state defining a powder.

In some further aspects, the plurality of antimicrobial microparticles in the dehydrated state have an average particle size of less than or equal to about 40 micrometers and in a rehydrated state has an average particle size of greater than or equal to about 70 micrometers.

In some aspects, after annealing and hydration, the plurality of antimicrobial microparticles define a hydrogel network.

In some aspects, the annealable polymeric hydrogel includes a polymeric precursor selected from the group consisting of: hyaluronic acid, polyalkylene glycol, alginate, gelatin, trehalose, and combinations thereof, the polymeric precursor further having a functional group selected from the group consisting of: norbornene, maleimide, cyclononane, bicyclononyne, dibenzocyclooctyne (DBCO), dibenzoazacyclooctyne (DIBAC), vinyl sulfone, azide, tetrazine, acrylate, methacrylate, and combinations thereof, and the nucleic acid includes deoxynucleic acid (DNA) and the polypeptide includes a histone.

In yet other aspects, the present disclosure relates to a method of making an antimicrobial microparticle. The method may comprise applying a first charged material having a first polarity to a surface of a microparticle having a second polarity opposite to the first polarity. The first charged material may comprise a polycation that is a polypeptide. The microparticle may comprise a core including an annealable polymeric hydrogel configured to be crosslinked. The method may also comprise applying a second charged material having the second polarity over the first charged material in a layer-by-layer process. The second charged material comprises a polyanion comprising a nucleic acid. The applying of the first charged material and the second charged material forms an antimicrobial matrix comprising the polypeptide and the nucleic acid around the microparticle surface.

In some aspects, the applying of the first charged material forms a first layer and the applying of the second charged material forms a second layer that defines a first antimicrobial matrix layer. The method may further comprises forming a plurality of antimicrobial matrix layers by repeated sequential applying of the first charged material and the second charged material.

In some aspects, the nucleic acid includes deoxynucleic acid (DNA) and the polypeptide includes a histone.

In some aspects, the annealable polymeric hydrogel includes a polymeric precursor selected from the group consisting of: hyaluronic acid, polyalkylene glycol, alginate, gelatin, trehalose, and combinations thereof, the polymeric precursor further having a functional group selected from the group consisting of: norbornene, maleimide, cyclononane, bicyclononyne, dibenzocyclooctyne (DBCO), dibenzoazacyclooctyne (DIBAC), vinyl sulfone, azide, tetrazine, acrylate, methacrylate, and combinations thereof, and the nucleic acid includes deoxynucleic acid (DNA) and the polypeptide includes a histone.

In some aspects, the method further comprises crosslinking the microparticle to form a hydrogel.

In some aspects, the microparticle is a plurality of microparticles and the method further comprises crosslinking the plurality of microparticles to form a porous microgel.

In other aspects, the present disclosure contemplates a method of treating a wound by applying an antimicrobial composition to a wound site of a subject. The antimicrobial composition may include a plurality of antimicrobial microparticles in a dehydrated state. Each antimicrobial microparticle includes a core having an annealable polymeric hydrogel configured to be crosslinked and an antimicrobial material disposed over at least a portion of a surface of the core. The antimicrobial material includes a polypeptide and a nucleic acid. The polypeptide may be a polycation and the nucleic acid may be a polyanion. The plurality of antimicrobial particles may be in a dehydrated state and when applied to the wound site, the antimicrobial particles rehydrate. The method further includes annealing the antimicrobial microparticles by applying an external source of energy to form a crosslinked antimicrobial hydrogel scaffold from the plurality of antimicrobial particles for tissue regeneration.

In certain aspects, the crosslinked hydrogel scaffold promotes wound healing by providing a bacteriostatic environment for tissue regeneration.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows images of annealable hydrogel (polyethylene-glycol-based) microbeads coated with an antimicrobial DNA-histone matrix material in accordance with certain aspects of the present disclosure with negative controls (histone control and DNA control). The annealable hydrogel (polyethylene-glycol-based) microbeads show a lack of non-specific staining of the microspheres with 4′,6-diamidino-2-phenylindole (DAPI) (bottom row - left) and lack of non-specific adsorption of DNA to microspheres in the absence of histones (bottom row - right). Brightfield images are shown in the top row-on left/right. Fluorescently-labeled microspheres are visible in both conditions (middle row-left/right). Scale bar is 650 micrometers.

FIG. 2 shows coating of annealable hydrogel (polyethylene-glycol-based) microbeads with different concentrations of DNA and histone materials. Concentrations of histones are shown on the y-axis at 2 micrograms (μg)/mL, 20 μg/mL, and 200 μg/mL. Concentrations of DNA are shown on the x-axis (at 50 nanograms (ng)/microliter (μL), 5 ng/μL, and 0.5 ng/μL). Scale bar is 650 micrometers. Microspheres are green and DNA is blue.

FIG. 3 shows magnified views from FIG. 2 of the annealable hydrogel (polyethylene-glycol-based) microbeads coated with an antimicrobial DNA-histone matrix material in accordance with certain aspects of the present disclosure. Microspheres are green and DNA is blue. Images are shown in Brightfield, Alexa Fluor (Beads), and DAPI (DNA) for the following samples: 200 μg/mL histone (HIS) and 50 ng/μL DNA, 20 μg/mL HIS and 50 ng/μL DNA, and 2 μg/mL HIS and 50 ng/μL DNA. Scale bar is 150 micrometers.

FIG. 4 also shows additional magnified views from FIG. 2 of the annealable hydrogel (polyethylene-glycol-based) microbeads coated with an antimicrobial DNA-histone matrix material in accordance with certain aspects of the present disclosure. Scale bar is 150 micrometers. Microspheres (green) and DNA (blue). Microspheres (green) and DNA (blue). Images are shown in Brightfield, Alexa Fluor (Beads), and DAPI (DNA) for the following samples: 20 μg/mL histone (HIS) and 5 ng/μL DNA, 2 μg/mL HIS and 5 ng/μL DNA.

FIG. 5 shows magnified views from FIG. 2 of the annealable hydrogel (polyethylene-glycol-based) microbeads coated with an antimicrobial DNA-histone matrix material in accordance with certain aspects of the present disclosure. Scale bar is 150 micrometers. Microspheres (green) and DNA (blue). Microspheres (green) and DNA (blue). Images are shown in Brightfield, Alexa Fluor (Beads), and DAPI (DNA) for the following samples: 20 μg/mL histone (HIS) and 0.5 ng/μL DNA and 2 μg/mL HIS and 0.5 ng/μL DNA.

FIG. 6 further shows magnified views from FIG. 2 of the annealable hydrogel (polyethylene-glycol-based) microbeads coated with an antimicrobial DNA-histone matrix material in accordance with certain aspects of the present disclosure, where concentrations of histones are shown on the y-axis and concentrations of DNA are shown on the x-axis. FIG. 6 also shows scanning electron microscopy (SEM) images of microspheres coated with DNA-histone matrix material (DHM). Scale bar is 200 micrometers. Microspheres are shown in red and DNA is green.

FIG. 7 shows representative scanning electron micrographs (SEMS) of various polyethylene-glycol-based microbeads coated with DNA-histone matrix material (DHM). Scale bars are 100 micrometers, 10 micrometers, and 2 micrometers.

FIG. 8 shows bacteriostatic properties of annealable hydrogel (polyethylene-glycol-based) microbeads coated with an antimicrobial DNA-histone matrix material in accordance with certain aspects of the present disclosure. Absorbance at a wavelength of 350 nm over time is shown for various bacteria. Specifically, the antimicrobial properties of microparticles according to certain aspects of the present disclosure were tested for the following bacteria: Staphylococcus aureus (MRSA), Acinetobacter baumannii, Escherichia coli, and Klebsiella pneumoniae.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

This present disclosure contemplates new antimicrobial compositions, incorporating antimicrobial microparticles having a core comprising an annealable polymeric hydrogel configured to be crosslinked. Generally, crosslinking is the reaction between respective polymer chains within each microparticle to crosslink them to one another. Annealing generally means that individual microgel particles/microbeads can be subjected to surface reactions and thus annealed together to form a porous scaffold structure. For example, a PEG-dithiol (crosslinker) and a photo initiator (LAP) can be used to promote annealing to form a porous scaffold structure.

In certain aspects, the present disclosure relates to an antimicrobial microparticle comprising a core formed of an annealable polymeric hydrogel and an antimicrobial matrix coating comprising a polycation (e.g., histone) and a polyanion (e.g., DNA). The microparticles are configured to be stored in a dehydrated, shelf-stable powder format and rehydrated in situ to form a scaffold for wound healing.

The present disclosure contemplates an antimicrobial microparticle that comprises a core comprising an annealable polymeric hydrogel configured to be crosslinked. The antimicrobial microparticles also have an antimicrobial material disposed over at least a portion of a surface of the core. In certain aspects, the antimicrobial material may be considered to be a shell or coating. In certain aspects, the antimicrobial matrix material covers greater than about 75% of the surface area of the microparticle, optionally greater than or equal to about 80%, optionally greater than or equal to about 85%, optionally greater than or equal to about 90%, optionally greater than or equal to about 95%, optionally greater than or equal to about 97%, optionally greater than or equal to about 95%, and in certain variations, the antimicrobial matrix material optionally covers between about 99 to about 100% of the surface area of the microparticle. As will be described further herein, the antimicrobial material comprises a polycation comprising a polypeptide and a polyanion comprising a nucleic acid. In certain aspects, the nucleic acid comprises deoxynucleic acid (DNA) and the polypeptide comprises a histone. Antimicrobial materials comprising such a polycation and a polyanion are described in U.S. Pat. No. 12,050,215 to Takayama, et al., the relevant portions of which are incorporated herein by reference. The significance of coating hydrogel beads with an antimicrobial matrix material is that these microbeads are annealable and thus can be crosslinked (or annealed) together through various click chemistry reactions and initiation mechanisms, one of which is through exposure to UV light. In this manner, they may form a porous microgel.

In various aspects, the present technology can be used to make antimicrobial amorphous hydrogels for chronic wound treatments, among other applications. In certain variations, the technology uses a DNA-histone matrix, which creates a net-like structure mimicking a natural defense mechanism mediated by neutrophils. Coating the DNA-histone network (antimicrobial material) onto portions of polymeric (e.g., hydrogel) beads, which can be dried and thus in a dehydrated state, creates an antimicrobial wound treatment. Hydrogels are polymeric materials formed from relatively lightly crosslinked networks of natural or synthetic polymers, which may contain a high-water content when in a hydrated state, for example, above 90% (weight/volume). The crosslinking of hydrogels can be achieved by various methods, such as ionic, covalent chemical (e.g., click chemistry), or actinic radiation (UV)-initiated chemical reactions. Both methods and degrees of crosslinking affect the resorbability of the hydrogel. As used herein, the hydrogel may also be considered to a microgel. Thus, the antimicrobial microparticles can form microgels.

Microgels may be formed of small particles (e.g., colloids) having at least one dimension on a microscale. Microgels are typically formed of three-dimensional networks of cross-linked polymer chains in a semi-solid or solid phase, which in this case, may be round particles or beads. Microgels, and their composite structures of granular hydrogels, have been gaining popularity due to the combined benefit of being injectable and instantaneously achieving microscale porosity. Spherical granular microgel systems have demonstrated promise in tissue engineering and regenerative medicine.

The coated hydrogel beads provided in accordance with various aspects of the present disclosure can be loaded with pharmaceutical active ingredients, such as antibiotics, then dried (e.g., in a powder form) and applied, introduced, or injected into wounds. By drying or dehydrated, it is meant that at least 80% of the initial moisture/water content is removed, optionally greater than about 85%, optionally greater than about 90%, optionally greater than about 95%, and in certain aspects, optionally greater than about 97% of the initial water/moisture is removed. The dehydrated antimicrobial powder composition may be considered to be shelf-stable, meaning that it can be stored in a sealed container at ambient temperature and pressure conditions, for greater than about 2 weeks, optionally greater than or equal to about 1 month, optionally greater than or equal to about 2 months, optionally greater than or equal to about 3 months, optionally greater than or equal to about 6 months, optionally greater than or equal to about 9 months, optionally greater than or equal to about 1 year, and in certain aspects, optionally greater than or equal to about 2 years.

The dehydrated antimicrobial powder composition then swells in the wound as is rehydrates and forms an antimicrobial wound dressing. This technology can heal dermal wounds more rapidly than conventional techniques by maintaining a hydrating environment, providing an ability to treat chronic wounds, such as ulcers, and further to minimize or prevent infections. Although dried hydrogel technologies exist, the present technology exhibits antimicrobial action, against both gram-positive and gram-negative bacteria, which can potentially decrease the economic burden associated with hospital-related infections.

A core region of the antimicrobial microparticle comprises an annealable polymeric hydrogel configured to be crosslinked. By annealable, it is meant that the polymeric hydrogel can be crosslinked (also referred to as “annealed”) through various crosslinking mechanisms, such as click chemistry reactions and initiation mechanisms, one of which is through exposure to actinic radiation (e.g., ultraviolet (UV) light). For example, the core may be formed from a polymeric precursor that can form a crosslinked polymeric hydrogel after being subjected to a gelation or annealing reaction (e.g., cross-linking reaction). The precursor may comprise a polymeric precursor (e.g., a monomer, oligomer, or polymer) that will form a polymeric or oligomeric backbone. The polymeric backbone can also have at least one reactive functional group incorporated therein. In certain aspects, the microbead with the polymeric precursor may be exposed to a source of energy and/or heat to promote crosslinking and/or a gelation reaction. This may occur before or after application to a target region (e.g., a wound or other target surface). For example, the microbead may be exposed to light, like actinic radiation, such as ultraviolet (UV) light. In certain other variations, electron beam (e-beam) crosslinking may be employed. In yet other variations, a pH of the fluid or environment in which the microbeads are disposed may be modified for promoting crosslinking and annealing. The precursor may comprise a crosslinker capable of reacting with a functional group in the polymeric backbone.

In certain aspects, a polymeric backbone may be selected from the group consisting of: hyaluronic acid, polyalkylene glycol (or polyalkylene oxide), such as polyethylene glycol (or polyethylene oxide (PEO)), alginate, gelatin, trehalose, and combinations thereof. In certain variations, the annealable polymeric hydrogel comprises a polymer selected from the group consisting of: polyalkylene glycol, hyaluronic acid, and combinations thereof. Suitable polyethylene glycol precursors include 4-arms or 8-arms, by way of non-limiting example. In certain aspects, the polymeric precursor backbone may be functionalized and thus further have a cross-linking or functional group selected from the group consisting of: norbornene, maleimide, cyclononane, bicyclononyne, dibenzocyclooctyne (DBCO), dibenzoazacyclooctyne (DIBAC), vinyl sulfone, azide, tetrazine, acrylate, methacrylate, and combinations thereof. In certain aspects, the functional or reactive group is thus capable of reacting with a crosslinking agent during the annealing/gelation reaction. In certain other aspects, the polymeric precursor may be capable of self-crosslinking, for example, alginate can ionically cross-link. In other variations, the polymeric precursor may be trehalose and may be particularly suitable for dehydration. Specific examples of suitable polymeric precursors, which may optionally be functionalized with a functional group for cross-linking, may be selected from the group consisting of: hyaluronic acid-norbornene, polyethylene glycol-norbornene, polyethylene glycol-bicyclononyne, polyethylene glycol-tetrabicyclononyne, polyethylene glycol-maleimide, polyethylene glycol-di-acrylate, polyethylene glycol-tetra-acrylate, gelatin-norbornene, gelatin-methacrylate, alginate, trehalose, and combinations thereof.

In certain variations, the present disclosure contemplates the use of one or more of the following polymer backbones: hyaluronic acid functionalized with norbornene (e.g., a UV photoinitiated, thiol-ene reaction), polyethylene glycol (PEG) with norbornene (e.g., a UV photoinitiated, thiol-ene reaction), PEG functionalized with bicyclononyne (e.g., strain-promoted azide-alkyne cycloaddition reaction), PEG functionalized with acrylate, e.g., PEG-diacrylate or tetra-acrylate (e.g., UV photoinitiated, free radical polymerization), PEG functionalized with maleimide (e.g., Michael addition, maleimide-thiol reaction), gelatin functionalized with methacrylate (e.g., UV photoinitiated, free radical polymerization), gelatin functionalized with norbornene (e.g., UV photoinitiated, thiol-ene reaction), alginate (e.g., ionic crosslinking), or trehalose (e.g., dehydration).

For example, the microbeads may be exposed to light, like actinic radiation, such as ultraviolet (UV) light for crosslinking/annealing. In certain other variations, electron beam (e-beam) crosslinking may be employed. In yet other variations, a pH of the fluid or environment, such as elevated temperature, in which the microparticles are disposed may be modified for promoting crosslinking and gelation. The precursor material forming the microparticle may comprise a crosslinking agent/crosslinker comprising a thiol group. In certain variations, the crosslinking agent may be degradable, for example, by enzymes or hydrolytic degradation. In certain variations, by way of example, a crosslinker is selected from the group consisting of: a dithiothreitol crosslinking agent, a polyethylene-glycol dithiol crosslinking agent, an enzymatically degradable plasmin-sensitive peptides with GCYKNSGCYKNSCG (YKNS) crosslinking agent, a hydrolytically degradable ethylene glycol bis(mercaptoacetate) (EGBMA) crosslinking agent, and combinations thereof. In some further aspects, the crosslinking agent is degradable and is one or more an enzymatically degradable plasmin-sensitive YKNS crosslinking agent or a hydrolytically degradable EGBMA crosslinking agent. Suitable glycol dithiol may have an average molecular weight ranging from 1,800 to 3,500. The precursor may also include a catalyst or initiator for initiating the crosslinking or gelation reaction. One suitable example of a photoinitiator is lithium phenyl-2,4,6-trimethylbenzoylphosphinate (LAP).

The microbeads formed may have a “microscale,” referring to a structure having at least one dimension (e.g., diameter) that is less than about 500 micrometers (μm), optionally less than about 400 micrometers, optionally less than about 300 micrometers, optionally less than about 250 micrometers, optionally less than about 200 micrometers, optionally less than about 150 micrometers, optionally less than about 100 micrometers, optionally less than about 75 micrometers, and in certain variations, optionally less than about 50 micrometers.

In various aspects, the antimicrobial microparticles are configured to be dehydrated and rehydrated. In certain variations, the antimicrobial particle in the dehydrated state has an average particle size of less than or equal to about 40 micrometers, optionally less than or equal to about 35 micrometers, and in certain aspects, optionally less than or equal to about 30 micrometers. In certain variations, the antimicrobial particle in the hydrated (or rehydrated) state has an average particle size of greater than or equal to about 70 micrometers, optionally greater than or equal to about 80 micrometers, and in certain aspects, optionally greater than or equal to about 90 micrometers.

By way of example, in certain variations, after forming the hydrogel microbeads and coating them with the antimicrobial material (described further herein), the coated hydrogel beads can be dehydrated into a lightweight powder (each bead having an diameter of greater than or equal to about 30 micrometers to less than or equal to about 50 micrometers following dehydration), which requires no special storage conditions, and could consequently be easily transported and carried into remote environments. When required, this antimicrobial powder could then be dispensed onto a target region, such as a wound site of a patient, where the dehydrated beads would become rehydrated/swelled by the aqueous portion of the blood/serum in/around the wound. Exposure to UV light/sunlight could then provide the means for cross-linking this material in situ and forming a hydrogel to form an antimicrobial/bacteriostatic wound dressing that better fills the uneven topology of natural wounds.

As noted above, the antimicrobial material may be a matrix that is disposed over at least a portion of a surface of the core, so that it at least partially covers the surface of the hydrogel bead. The antimicrobial matrix comprises a polycation (e.g., a positively charged polymer) and a polyanion (e.g., a negatively charged polymer) comprising a nucleic acid. In certain aspects, the polycation is a comprising a polypeptide, which may include proteins, bearing a cationic group or charge. For example, the polycation may include histones, citrullinated histones, spermine, spermidine, polyimine, ethylamine, poly-L-lysine, poly-D-lysine, polyaniline, polypyrrole, polyvinylamine, poly(diallyldimethylammonium chloride), and any combinations thereof. In certain variations, the polycation is a polypeptide. For example, the polypeptide may comprise a histone, including citrullinated histones.

The polyanion may include nucleic acids, such as deoxynucleic acid (DNA), including by way of example, genomic DNA, mitochondrial DNA, bacterial DNA, viral DNA, synthetic DNA, oxidized DNA, single stranded DNA, ribonucleic acid (RNA), short interfering sequence of double stranded RNA (siRNA), messenger RNA (mRNA), transfer RNA (tRNA), ribosomal RNA, small nuclear RNA, synthetic RNA, miRNA, shRNA, viral RNA, oligonucleotides, and any combinations thereof. Other polyanions include polystyrene sulfonate, polyglutamic acid, hyaluronic acid, and combinations thereof. In some embodiments, the nucleic acid is between approximately 1 kilobase and 1 megabase in length (e.g., 1 kb, 10, kb, 50 kb, 100 kb, 500 kb, 1000 kb).

In certain variations, the antimicrobial matrix material includes a nucleic acid comprising deoxynucleic acid (DNA), such as genomic DNA, and the polypeptide comprises a histone. In certain aspects, the antimicrobial material comprises greater than or equal to about 0.5 nanograms/microliter to 50 nanograms/microliter of DNA and greater than or equal to about 2 micrograms/milliliter to 200 micrograms/milliliter of histone.

In certain variations, an antimicrobial composition is provided that includes a plurality of antimicrobial microparticles, wherein each microparticle comprises a core comprising an annealable polymeric hydrogel configured to be crosslinked and an antimicrobial matrix disposed over at least a portion of a surface of the core. As discussed above, the antimicrobial matrix comprises a polycation comprising a polypeptide (e.g., histone) and a polyanion comprising a nucleic acid (e.g., DNA). While the plurality of antimicrobial particles may be provided by themselves as the antimicrobial composition, in other variations, the antimicrobial particles may be provided in a suitable carrier material, such as a biomedical or pharmaceutically acceptable material or excipient, as are well known in the art. In certain aspects, the antimicrobial composition may further comprise at least one active ingredient.

Pharmaceutically acceptable materials may be those which are suitable for use in contact with the tissues of humans and other animals without resulting in excessive toxicity, irritation, allergic response, or other problems or complications, commensurate with a reasonable benefit/risk ratio. In certain aspects, biocompatible or pharmaceutically acceptable materials are those that are approved for use in humans by an appropriate regulatory agency, such as the Federal Drug Administration (FDA) in the United States; the European Commission (EC)/ European Medicines Agency (EMEA) in Europe; or Health Products and Food Branch (HPFB) in Canada.

A pharmaceutical active ingredient is a drug or other compound used for the prevention or treatment of a condition or disorder in a human or other animal, the prevention or treatment of a physiological disorder or condition, or to provide a benefit that outweighs potential detrimental impact in a conventional risk-benefit assessment. The active ingredient may be used for the treatment or prevention of systemic, acute, or chronic disorders, such as infections, inflammation, pain control, autoimmune diseases, cancer, cardiovascular disease, stroke, diabetes, severe respiratory infection, and the like.

Suitable compounds, which may be pharmaceutical active ingredients or new chemical entities, include by way of non-limiting example, various drugs or potential drugs (e.g., new chemical entities), including antimicrobial agents, such as antibacterial agents, antiviral agent, antifungal agents; anti-inflammatory agents; anesthetic, analgesic or pain-killing agents; non-steroidal anti-inflammatory agents (NSAIDs); antipyretic agents, prostaglandin inhibitors; platelet inhibitors; free radical scavengers; nutrients; antibiotics; chemotherapy agents; antineoplastic/ anti-miotic agents; anti-proliferative agents; anti-rejection drugs; anti-thrombotic agents; anti-coagulants; antioxidants; nucleic acids; saccharides; sugars; nutrients; hormones; cytotoxin; hormonal agonists; hormonal antagonists; inhibitors of hormone biosynthesis and processing; antigestagens; antiandrogens; DNA de-methylating agents; cholesterol-lowering agents; vasodilating agents; endogenous vasoactive interference agents; angiogenic substances; cardiac failure active ingredients; targeting toxin agents; and combinations thereof. The description of these suitable organic compounds/pharmaceutical active ingredients is merely exemplary and should not be considered as limiting as to the scope of compounds or active ingredients which can be incorporated into an antimicrobial composition, as all suitable organic molecules and/or active ingredients known to those of skill in the art for these various types of compositions are contemplated. Furthermore, an organic compound may have various functionalities and thus, can be listed in an exemplary class above; however, may be categorized in several different classes of active ingredients.

Various suitable active ingredients are disclosed in Merck Index, An Encyclopedia of Chemicals, Drugs, and Biologicals, Thirteenth Edition (2001) by Merck Research Laboratories and the International Cosmetic Ingredient Dictionary and Handbook, Tenth Ed., 2004 by Cosmetic Toiletry and Fragrance Association, and at http://www.drugbank.ca/, the relevant portions of each of which are incorporated herein by reference. Each additional reference cited or described herein is hereby expressly incorporated by reference in its respective entirety.

In certain variations, the active ingredient may be one or more antimicrobial agents. “Antimicrobial” refers to a composition that has at least one of an antibacterial, an antiviral, and an antifungal activity. In certain variations, the antimicrobial composition according to the present disclosure provides antibacterial activity against gram-positive bacteria, gram-negative bacteria, or both gram-positive and gram-negative bacteria. The antimicrobial microparticles of the present disclosure are believed to enhance the potency of antibiotics, when they are delivered concurrently. It is believed that multiple species of bacteria become more susceptible to multiple antibiotics when in the presence of DNA-histone antimicrobial materials provided on the surfaces of the microbeads, which may form a hydrogel or microgel after annealing/crosslinking. In this manner, lower concentrations of antibiotics as compared to conventional antibiotic treatments may be possible, as well, when such antibiotics are concurrently delivered in the presence of the antimicrobial compositions of the present teachings.

In certain aspects, the present disclosure provides a method of treating a wound by applying an antimicrobial composition comprising a plurality of antimicrobial particles, as described above, to a wound site (e.g., abrasion, incision, laceration, puncture, and the like) of a subject, such as an animal, like a human. The plurality of antimicrobial particles may be in a dehydrated state when applied to the wound site, where they rehydrate. For example, exposure of the antimicrobial composition to bodily fluids, such as wound exudate, can transform the antimicrobial particles into a rehydrated state. The antimicrobial particles may be subsequently annealed —for example, via application of an external source of energy or an initiation source, like ultraviolet light—to form a crosslinked antimicrobial hydrogel scaffold from the plurality of antimicrobial particles. The hydrogel scaffold promotes tissue regeneration. In certain aspects, the crosslinked hydrogel scaffold promotes wound healing by providing a bacteriostatic environment for tissue regeneration.

In various other aspects, the present disclosure also provides new methods of forming the antimicrobial microparticles. The methods described in U.S. Pat. No. 12,050,215 to Takayama, et al. discussed above employ a serial multi-step dehydration/rehydration process to pattern the DNA-histone matrix on a solid substrate. In certain aspects, the present disclosure contemplates new methods of forming the antimicrobial material. In such a method, a layer-by-layer process (using opposite alternating charges) may be used to form the antimicrobial material on regions of the surface of the hydrogel.

The present disclosure contemplates a method of making an antimicrobial microparticle. The method may comprise applying a first charged material having a first polarity to a surface of a microparticle (or a plurality of microparticles) having a second polarity opposite to the first polarity. The microparticle/hydrogel beads in certain variations may have a negative surface charge. For example, where the microparticle/microbead comprises polyethylene glycol, the second polarity or charge may be a negative surface charge and the first charged material may have a first polarity or first charge that is positive and thus is a cation. The method may also comprise applying a second charged material having the second polarity over the first charged material in a layer-by-layer process. As noted above, the second charge may be a second opposite polarity or negative charge and thus an anion. The first charged material and the second charged material each comprise a component distinct from one another. Initially, a layer of polycations, namely histones (while in solution), may be deposited on each a surface of each hydrogel bead. In one example, the first charged material is a histone and the second charged material is DNA. After polycations (histones) are applied to the microparticle surface, polyanions (e.g., DNA) may be applied by utilizing the positive surface charge of the now histone-coated beads to add a DNA layer over the histone layer on each microbead. The applying of the first charged material and the second charged material forms an antimicrobial matrix around the microparticle surface (at least partially or optionally fully covering the surface). In certain variations, the method may form an antimicrobial matrix material over a plurality of surfaces of a plurality of microstructures. SEM and fluorescence-labeled confocal images appear to confirm that a matrix material is formed.

The applying of the first charged material forms a first layer and the applying of the second charged material forms a second layer that defines a first antimicrobial matrix layer. The methods may further comprise forming a plurality of antimicrobial matrix layers over the microparticle surface by repeated sequential applying of the first charged material and the second charged material.

In some aspects, the nucleic acid includes deoxynucleic acid (DNA) and the polypeptide includes a histone.

In some aspects, the annealable polymeric hydrogel includes a polymeric precursor selected from the group consisting of: hyaluronic acid, polyalkylene glycol, alginate, gelatin, trehalose, and combinations thereof, the polymeric precursor further having a functional group selected from the group consisting of: norbornene, maleimide, cyclononane, bicyclononyne, dibenzocyclooctyne (DBCO), dibenzoazacyclooctyne (DIBAC), vinyl sulfone, azide, tetrazine, acrylate, methacrylate, and combinations thereof, and the nucleic acid includes deoxynucleic acid (DNA) and the polypeptide includes a histone.

In some aspects, the method further comprises crosslinking the microparticle to form a hydrogel. The method further comprises crosslinking a plurality of microparticles. The method further comprises crosslinking the plurality of microparticles to form a porous microgel.

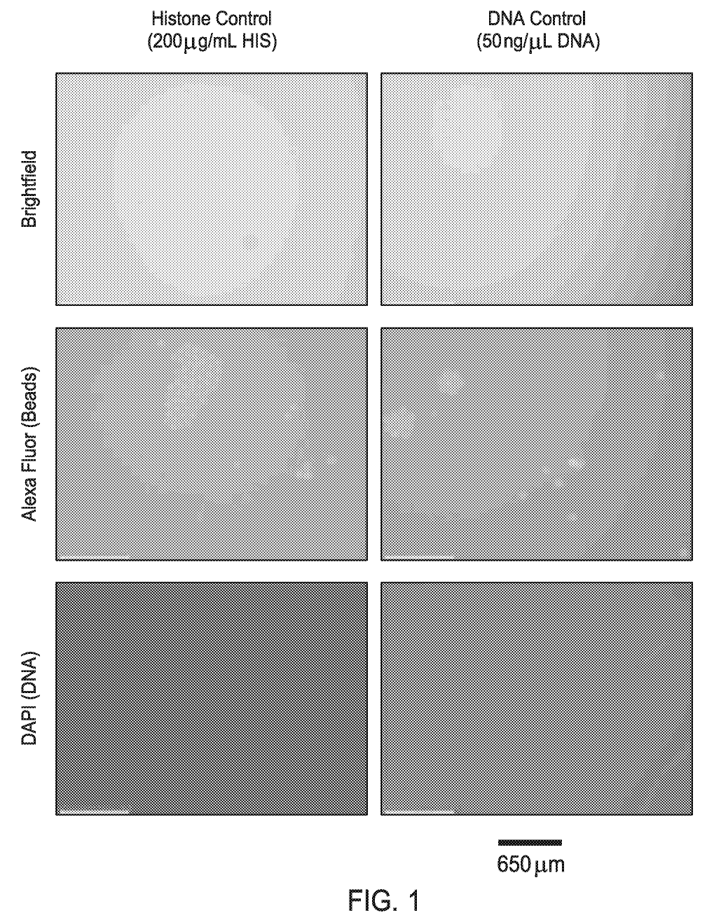

The antimicrobial microparticles prepared in accordance with certain aspects of the present disclosure are characterized as follows in FIGS. 1–8.

FIG. 1 shows annealable hydrogel (polyethylene-glycol-based) microbeads coated with an antimicrobial DNA-histone matrix material in accordance with certain aspects of the present disclosure. Scale bar is 650 micrometers. Negative control images (histone control and DNA control) show lack of non-specific staining of PEG-based hydrogel microspheres with DAPI (bottom left) and lack of non-specific adsorption of DNA to microspheres in the absence of histones (bottom right). Fluorescently-labeled microspheres are visible in both conditions (middle-left/right).

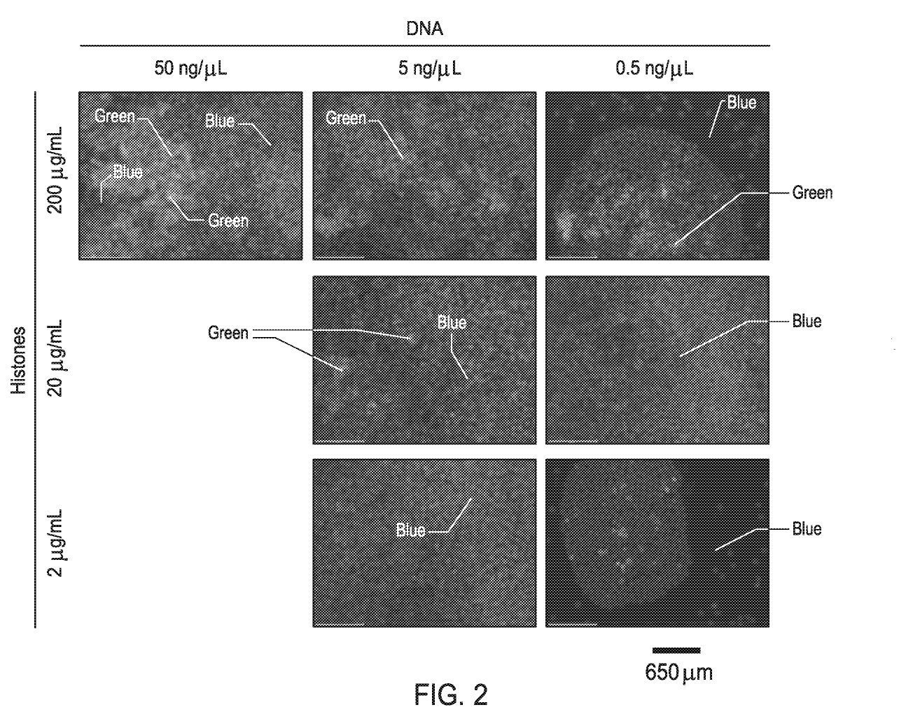

FIG. 2 shows coating of annealable hydrogel (polyethylene-glycol-based) microbeads with different concentrations of DNA and histones materials. The polyethylene-glycol-based microspheres/beads are polyethylene glycol-norbornene (PEG-norbornene) microspheres. PEG hydrogels carry a slightly negative surface charge, so PEG-norbornene microspheres are incubated in two distinction solutions, the first solution containing histones followed by the second solution containing DNA. Concentrations of histones range from 2 micrograms (μg)/mL, 20 μg/mL, to 200 μg/mL. Concentrations of DNA range between 50 nanograms (ng)/microliter (μL), 5 ng/μL, to 0.5 ng/μL. This DNA-histone matrix formed on the microspheres shows that at high histone and DNA concentrations, DNA-histone complexes primarily form in solution (and not on the surface of microspheres). As the concentration of these components is reduced, complexation shifts such that it primarily occurs on the bead surface.

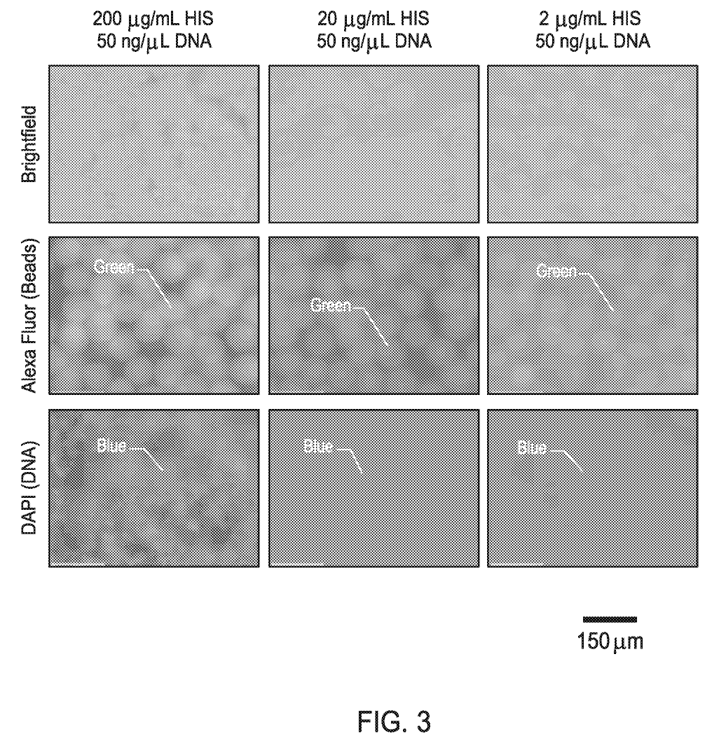

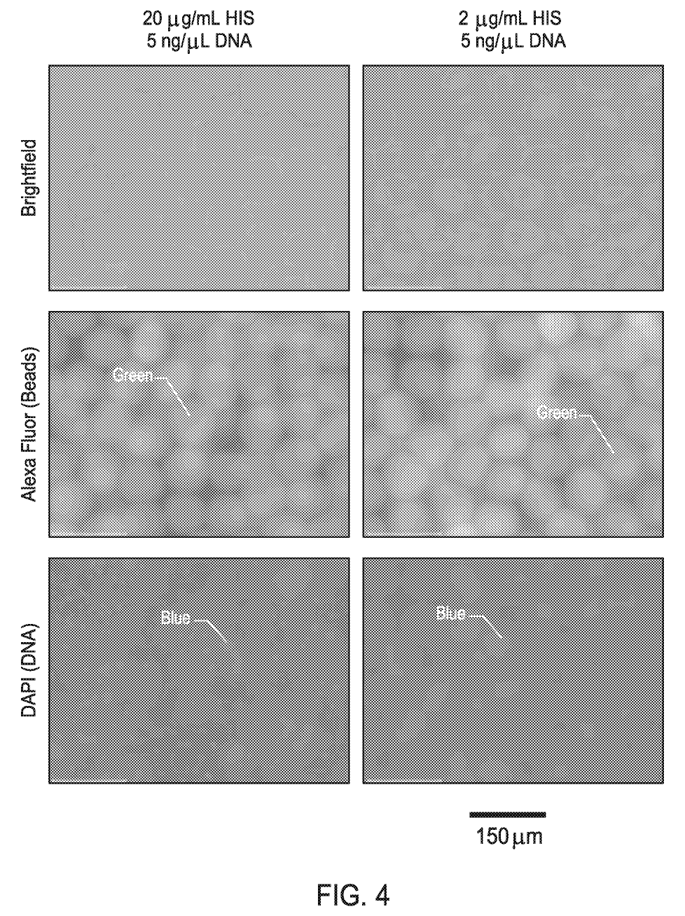

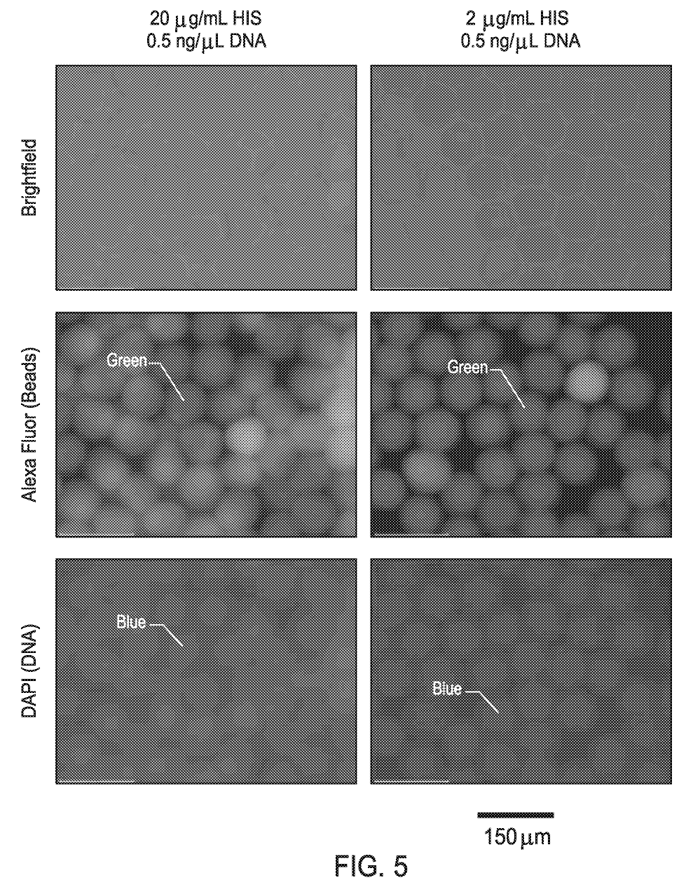

FIGS. 3, 4, and 5, show magnified views from FIG. 2 of the annealable hydrogel (polyethylene-glycol-based) microbeads coated with an antimicrobial DNA-histone matrix material in accordance with certain aspects of the present disclosure. Microspheres are labeled with Alex Fluor and shown in green in the middle row, while DNA is shown in blue for the bottom row. FIG. 3 shows samples prepared with 200 μg/mL histone (HIS) and 50 ng/μL DNA, 20 μg/mL HIS and 50 ng/μL DNA, and 2 μg/mL HIS and 50 ng/μL DNA. FIG. 4 shows samples prepared with 20 μg/mL histone (HIS) and 5 ng/μL DNA, 2 μg/mL HIS and 5 ng/μL DNA. FIG. 5 shows samples prepared with 20 μg/mL histone (HIS) and 0.5 ng/μL DNA and 2 μg/mL HIS and 0.5 ng/μL DNA. The results in the magnified images in FIGS. 3–5 further show that as concentration of DNA and histones in the solutions are reduced, they primarily deposit on the microbead surfaces as DNA-histone matrix material.

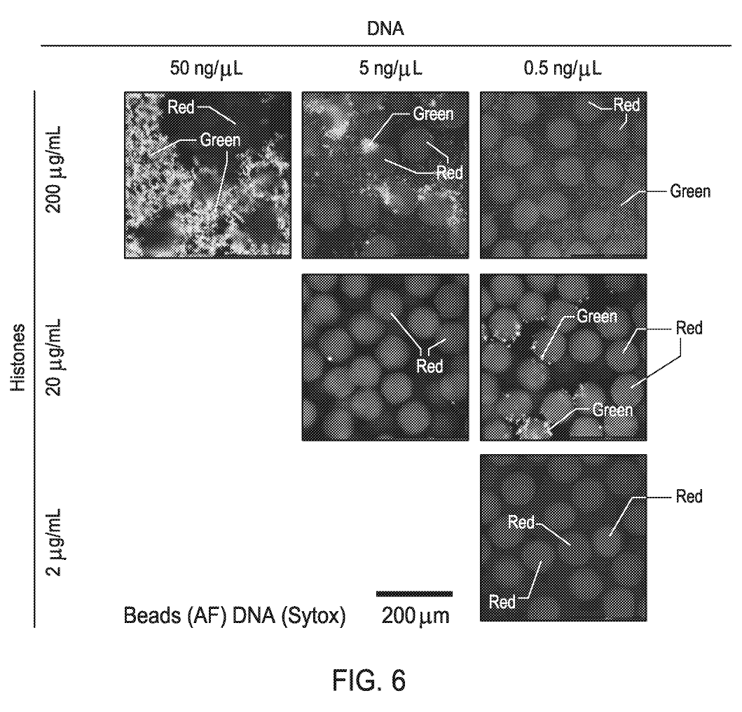

FIG. 6 further shows additional magnified views from FIG. 2 of the annealable hydrogel (polyethylene-glycol-based) microbeads coated with an antimicrobial DNA-histone matrix material in accordance with certain aspects of the present disclosure, along with scanning electron microscopy (SEM) images of microspheres coated with DNA-histone matrix material (DHM). Microspheres (red) and DNA (green). This further demonstrates that at high histone and DNA concentrations, DNA-histone complexes primarily form in solution rather than on the surface of PEG-based microspheres, as would be desired. As the concentration of DNA and histones is reduced; however, complexation of DNA and histone shifts such that it primarily occurs on the bead surface.

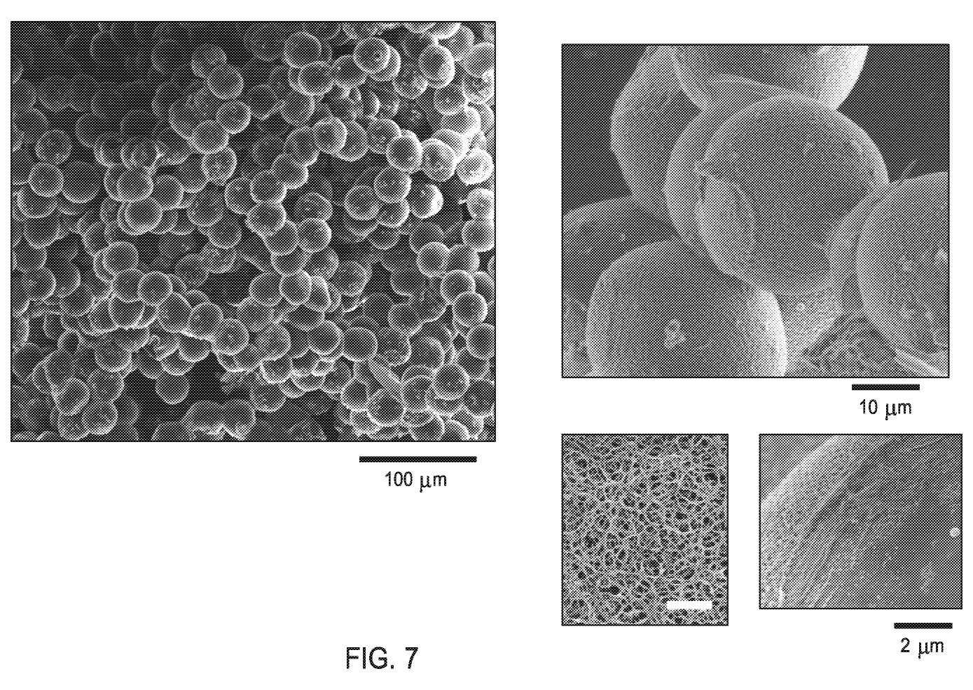

FIG. 7 shows representative scanning electron micrographs (SEMS) of polyethylene-glycol-based microbeads coated with an antimicrobial DNA-histone matrix (DHM) material corroborating fluorescence image data and indicating the methods of forming antimicrobial particles according to certain aspects of the present disclosure formed DNA-histone matrix material (DHM) coated microspheres. Partial/patchy coating can be seen in the image at top-left, while a more complete coating can be seen at top-right. The image on the bottom-right is a magnified view showing what appears to be the boundary region between the native/uncoated microparticle (MP) surface and the DHM coating. The qualitative determination of whether the structures visible on the microsphere surface were DHMs or not was based on both positive DAPI (DNA) staining (as observed via fluorescence microscopy, see e.g., FIGS. 1, 3–5) and morphological comparisons with previously-collected scanning electron micrographs.

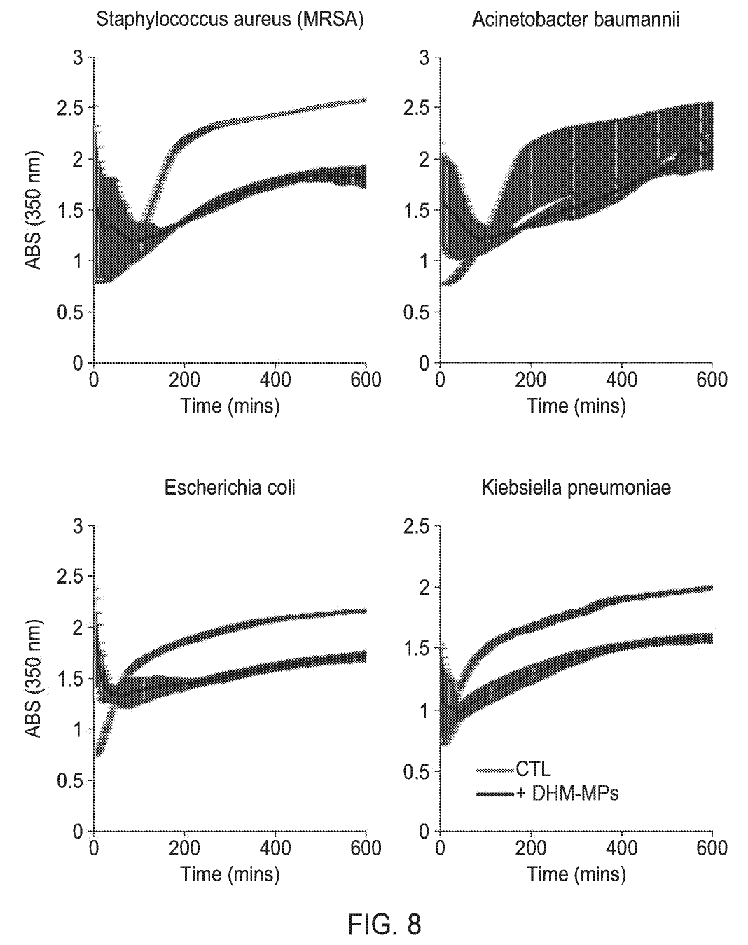

FIG. 8 shows bacteriostatic properties of annealable hydrogel (polyethylene-glycol-based) microbeads or microparticles (MP) coated with an antimicrobial DNA-histone matrix material (DHM) in accordance with certain aspects of the present disclosure. Specifically, the antimicrobial microparticles according to certain aspects of the present disclosure were tested for the following bacteria: Staphylococcus aureus (MRSA), Acinetobacter baumannii, Escherichia coli, and Klebsiella pneumoniae.

Absorbance at a wavelength of 350 nm over time is shown for these bacteria. To determine whether DHM-coated microspheres exhibited bacteriostatic properties; coated microspheres were dehydrated in individual wells of a 96-well plate (via vacuum desiccation). Bacteria (approximately 1e6 cells per well) were then added, and growth of these cultures in the presence or absence of microparticles coated with an antimicrobial DNA-histone matrix material (DHM-MPs) was measured via absorbance (350 nm). Based on this initial experiment, it appears DHM-MPs effectively suppress bacterial growth.

Various aspects of the present disclosure thus provide annealed hydrogel beads (also referred to as microgels) having antimicrobial efficacy, which may be particularly advantageous for wound healing applications. This is particularly due to the ability of hydrogels/microgels to promote cell infiltration through their interconnected pores, as well as their ability to be injected or applied to dermal wounds. These materials may be suitable for wound healing and cell and tissue regeneration, among other applications. In certain variations, the antimicrobial composition comprising the antimicrobial microparticles according to the present disclosure can be directly applied to a wound or to a tissue of a subject, such as an animal. In certain aspects, the plurality of antimicrobial particles are in a dehydrated state defining a powder. The powder may be applied to the wound or tissue. After annealing and hydration, the plurality of antimicrobial particles define a hydrogel network. Alternatively, the antimicrobial composition may be introduced via a carrier by injection. Further, the present disclosure contemplates a wound dressing comprising the antimicrobial composition, a medical device or a medical implant comprising the antimicrobial composition. Dried hydrogels can be advantageous for storage and transportation. For example, the antimicrobial hydrogels can be used for chronic wound treatment and/or treatment of ulcers (such as diabetic, venous, etc.), burns, and the like. By way of non-limiting example, the present disclosure contemplates antibacterial wound dressings, antibiotic-releasing patches, antibacterial scaffolds for burns and/or tissue regeneration, antibacterial coatings for medical implants, controlled antibiotic delivery particles, and microbial resistant dental implant coatings, among others. Other applications may include incorporating such antimicrobial compositions into tissue scaffolds and cellular supports.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An antimicrobial microparticle comprising:
a core comprising an annealable polymeric hydrogel configured to be crosslinked; and
an antimicrobial matrix material disposed over at least a portion of a surface of the core, wherein the antimicrobial matrix material comprises a polypeptide and a nucleic acid.

2. The antimicrobial microparticle of claim 1, wherein the annealable polymeric hydrogel is configured to be crosslinked when exposed to actinic radiation.

3. The antimicrobial microparticle of claim 1 is configured to be dehydrated and rehydrated.

4. The antimicrobial microparticle of claim 3, wherein the antimicrobial microparticle in a dehydrated state has an average particle size of less than or equal to about 40 micrometers and in a rehydrated state has an average particle size of greater than or equal to about 70 micrometers.

5. The antimicrobial microparticle of claim 1, wherein the annealable polymeric hydrogel comprises a polymeric precursor selected from the group consisting of: hyaluronic acid, polyalkylene glycol, alginate, gelatin, trehalose, and combinations thereof, the polymeric precursor further having a functional group selected from the group consisting of: norbornene, maleimide, cyclononane, bicyclononyne, dibenzocyclooctyne (DBCO), dibenzoazacyclooctyne (DIBAC), vinyl sulfone, azide, tetrazine, acrylate, methacrylate, and combinations thereof.

6. The antimicrobial microparticle of claim 1, wherein the annealable polymeric hydrogel comprises polyethylene glycol and further comprising at least one reactive group for crosslinking.

7. The antimicrobial microparticle of claim 1, wherein the annealable polymeric hydrogel comprises a crosslinking agent.

8. The antimicrobial microparticle of claim 1, wherein the nucleic acid comprises deoxynucleic acid (DNA) and the polypeptide comprises a histone.

9. The antimicrobial microparticle of claim 1, comprising greater than or equal to about 0.5 nanograms/microliter to 50 nanograms/microliter of DNA and greater than or equal to about 2 micrograms/milliliter to 200 micrograms/milliliter of histone.

10. An antimicrobial composition comprising:
a plurality of antimicrobial microparticles, wherein each microparticle comprises a core comprising an annealable polymeric hydrogel configured to be crosslinked and an antimicrobial material disposed over at least a portion of a surface of the core, wherein the antimicrobial material comprises a polypeptide and a nucleic acid.

11. The antimicrobial composition of claim 10 configured to be directly applied to a wound or to a tissue.

12. A wound dressing comprising the antimicrobial composition of claim 10.

13. A medical device comprising the antimicrobial composition of claim 10.

14. A medical implant comprising the antimicrobial composition of claim 10.

15. The antimicrobial composition of claim 10 further comprising at least one active ingredient.

16. The antimicrobial composition of claim 10 further comprising at least one antimicrobial agent.

17. The antimicrobial composition of claim 10, wherein the plurality of antimicrobial microparticles are in a dehydrated state defining a powder.

18. The antimicrobial composition of claim 17, wherein the plurality of antimicrobial microparticles in the dehydrated state have an average particle size of less than or equal to about 40 micrometers and in a rehydrated state has an average particle size of greater than or equal to about 70 micrometers.

19. The antimicrobial composition of claim 17, wherein after annealing and hydration, the plurality of antimicrobial microparticles define a hydrogel network.

20. A method of treating a wound in a subject comprising:
applying an antimicrobial composition to a wound site of the subject, wherein the antimicrobial composition comprises a plurality of antimicrobial microparticles in a dehydrated state, wherein each antimicrobial microparticle of the plurality includes a core having an annealable polymeric hydrogel configured to be crosslinked and an antimicrobial material disposed over at least a portion of a surface of the core, wherein the antimicrobial material includes a polypeptide and a nucleic acid, wherein the plurality of antimicrobial microparticles rehydrate when applied to the wound site; and
annealing the antimicrobial microparticles in the wound site by applying an external source of energy to form a crosslinked antimicrobial hydrogel scaffold from the plurality of antimicrobial microparticles for tissue regeneration.
